(19) United States
(12) Patent Application Publication
(10) Pub. No.: US 2008/0204478 A1
(43) Pub. Date: Aug. 28, 2008

(54) Method of enlarging display content of a portable electronic apparatus

(75) Inventor: Kun-Chi Hung, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/709,686

(22) Filed: Feb. 23, 2007

(51) Int. Cl. G09G 5/00

(52) U.S. Cl. 345/663

(57) ABSTRACT

The present invention is to provide a method of enlarging display content of an electronic apparatus having an enlarge display mode, which comprises the steps of determining whether or not the enlarge display mode is being activated; reading at least one enlarge parameter preset in the enlarge display mode when the enlarge display mode is activated; enlarging the content outputted by a man-machine interface according to the enlarge parameter; canceling an external frame of a decorative screen of the man-machine interface for ornamenting images, and displaying the enlarged content in accordance with the enlarge parameter on a display of the portable electronic apparatus In such a way, the user is able to view the enlarged content of the man-machine interface being outputted without changing resolution of the display.

### FIELD OF THE INVENTION

The present invention relates to a portable electronic apparatus, more particular to a method for enlarging content (including text or picture )of a man-machine interface to be outputted by a portable electronic apparatus according to an enlarge parameter and then displaying the content to a display of the portable electronic apparatus while outputting the same.

### BACKGROUND OF THE INVENTION

Recently, information products, are being rapidly developed, which bring mankind unlimited convenience and become an undetachable part of human's daily life. As more kinds of information products become available in market, more attention has been paid on the demand for better functionality and higher quality. Accordingly, almost all information product manufacturers have to cater consumer' requirements to adding more and more new functionalities to their information products. Especially, portable communication products, e.g., cell phones, personal digital assistants (PDAs), which are featured as being slim and portable, have become very important personal communication tools in daily life. As the market of portable communication products growing fast, there are uncountable brands and manufacturers competing for this cake. However, like any other competitive market, those incapable of satisfying consumer' higher demand would be automatically time out from the market. Therefore, whether a newly developed product comes up with more convenient and more effective functionality becomes an import criterion for determining how outstanding a manufacturer is in manufacturability in the field.

Since all products are developed heading toward multi-function, slimness, and refinement, internal spaces of the products become smaller and smaller. After adding kinds of different functionalities in addition, such portable communication products have more and more complicated structures to design which requires smaller display area. However, even though the displays are smaller than before, they have to perform better in displaying refining and exquisite images. As such, the displays must be set in display modes of higher resolution. Unfortunately, this results in displaying smaller fonts and/or figures on a display that is already too small.

As such, images displayed by such a portable communication product are not easy for reading to those with poor vision. Furthermore, it is also have to be considered that some manufacturers often employ external decorative frames enclosing the displayed images, which further limit areas for displaying images. However, lowering the resolution for clearly viewing the displayed image apparently is not a good solution for the contradiction, because it makes the high resolution design meaningless. Therefore, how to enable the users to view larger content on the display in higher resolution becomes a problem to be solved in the art.

### SUMMARY OF THE INVENTION

In view of the foregoing shortcomings of the prior art, the inventor of the present invention based on years of experience to conduct extensive researches and experiments and finally invented a method of enlarging display content of a portable electronic apparatus.

Therefore, it is a primary objective of the present invention to provide a method of enlarging display content of a portable electronic apparatus. When the portable electronic apparatus displays a man-machine interface to be outputted, content (such as text or picture) of the man-machine interface are enlarged according to an enlarge parameter and thereafter outputted to a display of the portable electronic apparatus. In such a way, the display of the portable electronic apparatus displays larger content for the user thereof to view the content of the man-machine interface without changing a resolution of the display.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a flow chart for illustrating an embodiment of the present invention;

FIG. 2 shows an appearance of a portable electronic apparatus and a view of which showing display content being enlarged;

FIG. 3 is a flow chart illustrating the portable electronic apparatus outputting the enlarged display content to a display thereof; and

FIG. 4 is a view illustrating fonts or pictures displayed on the display.

### DETAILED DESCRIPTION OF THE PREFERRED EMBODIMENTS

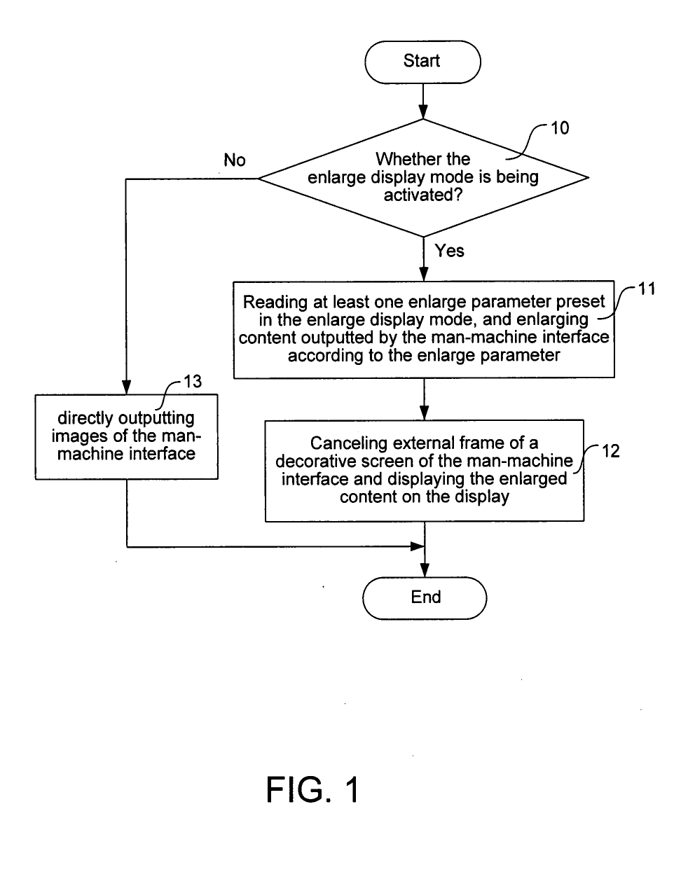

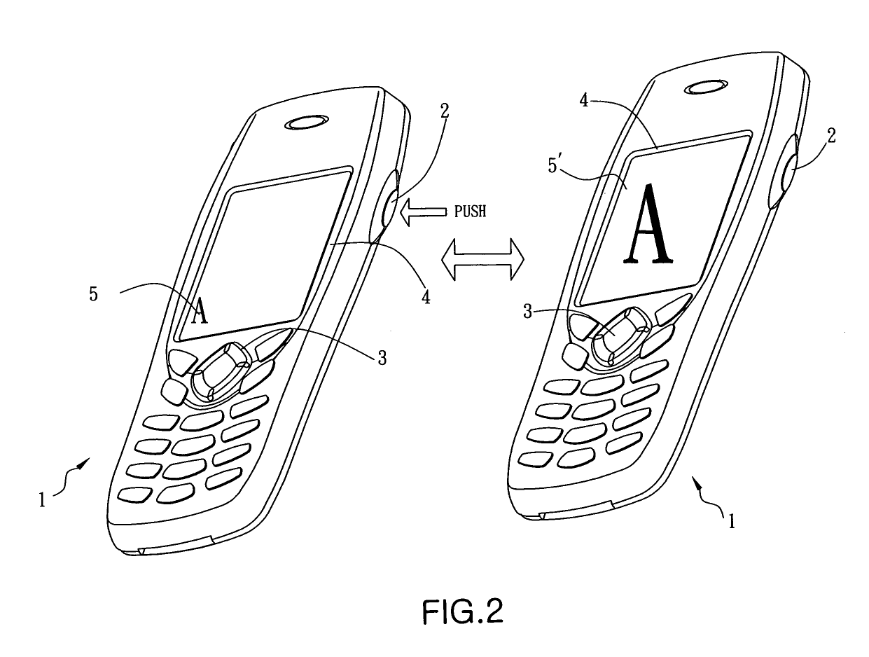

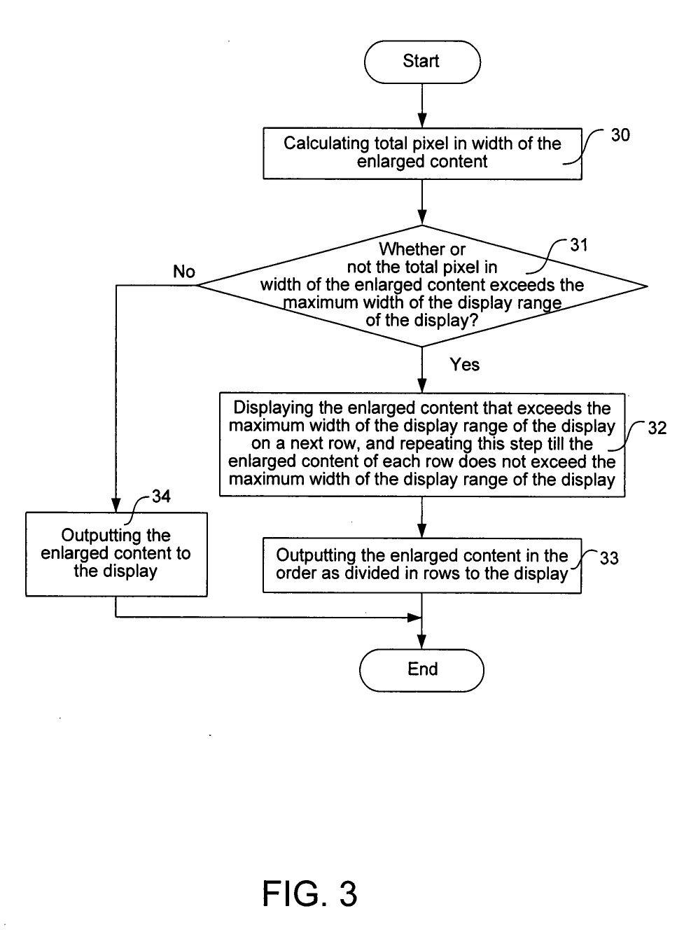

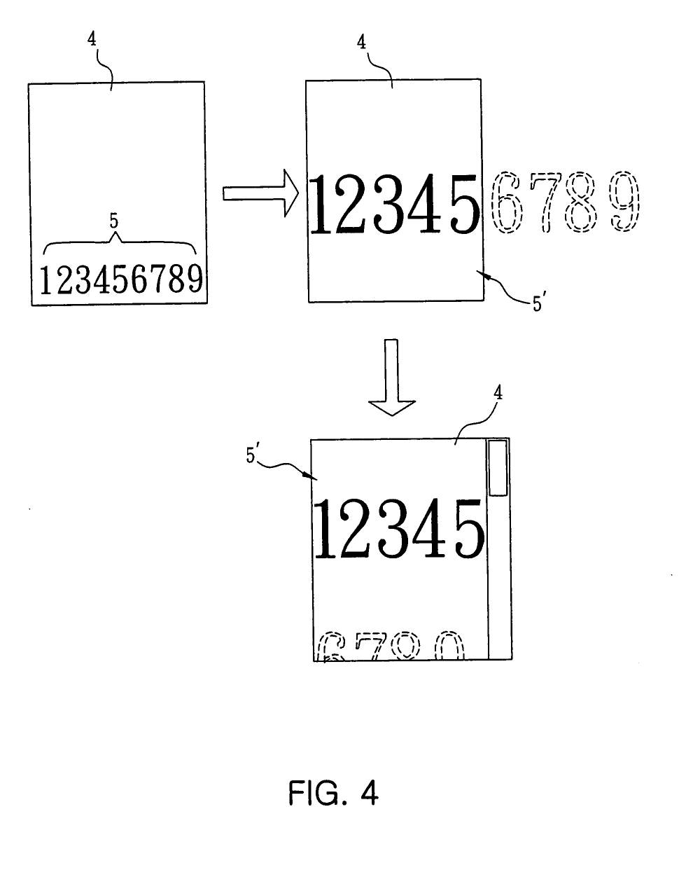

Generally, displays of conventional portable electronic apparatuses, such as cell phones, PDAs, or smart phones, are able to display man-machine interfaces with different functions including: displaying calling ID, displaying dialing number, sending/receiving text or picture message. Typically, there also distributes input elements, for example buttons of a dial pad, under each of the man-machine interfaces, which allow the users to use the functions such as dialing a call, receiving a call, editing telephone numbers, amending telephone numbers, or setting calling ID display. However, all conventional displays of current portable electronic apparatuses output man-machine interfaces with high resolutions, which causes fonts displayed on the man-machine interfaces relatively small in size. Therefore, a man-machine interface displaying such small size fonts is inconvenient for those having poor vision to use. As such, for solving the foregoing problems, a method of enlarging display content of a portable electronic apparatus is provided according to the present invention. Referring to FIGS. 1 and 2, the method is adapted for a portable electronic apparatus 1. The portable electronic apparatus 1 has an enlarge display mode. The portable electronic apparatus 1 output a man-machine interface by conducting the following steps:
(10) In this step, the portable electronic apparatus 1 determines whether or not the enlarge display mode is being activated; if it is, then goes to step (11); if not, then goes to step (13). According to a preferred embodiment of the present invention, the portable electronic apparatus 1 includes a switching device 2 disposed on a surface of the portable electronic apparatus 1. The switching device 2 is adapted to emit a switching signal when being pressed. The portable electronic apparatus 1 is adapted to switch from enabling the enlarge display mode to disabling the enlarge display mode according to the switching signal. The portable electronic apparatus 1 is also adapted to switch from disabling the enlarge display mode to enabling the enlarge display mode according to the switching signal. According to another embodiment of the present invention, when a user operates an input element, for example a button 3, of portable electronic apparatus 1, and enters a man-machine interface of the enlarge display mode, at least a enabling/disabling option is presented on a display 4 of the portable electronic apparatus 1. The enabling/disabling option allows the user to operate the input element to select or cancel the option, which generates a switching signal. The portable electronic apparatus 1 is adapted to switch from enabling the enlarge display mode to disabling the enlarge display mode according to the switching signal. The portable electronic apparatus 1 is also adapted to switch from disabling the enlarge display mode to enabling the enlarge display mode according to the switching signal.
(11) In this step, the portable electronic apparatus 1 reads at least one enlarge parameter preset in the enlarge display mode, and enlarges a content (i.e. a text in this embodiment) 5 outputted by the man-machine interface according to the enlarge parameter. According to an aspect of the embodiment according to the present invention, the enlarge parameter including font size, font codes and picture enlarging ratio that are pre-stored in the portable electronic apparatus 1, is selected by the user via the input element 3;
(12) In this step, the portable electronic apparatus 1 cancels an external frame of a decorative screen of the man-machine interface for ornamenting images, and displays an enlarged content 5′ in accordance with the enlarge parameter on the display 4. It is to be noted that a displaying range of the display 4 is represented with pixels, while a displaying range of the content on the display 4 is also represented with pixels. Therefore, in order to avoid the content displayed on a single row on the display exceeding the maximum width of the display range of the display 4, the enlarged content 5′ will be displayed on the display 4 by the portable electronic apparatus 1 according to the following steps, as shown in FIGS. 3 and 4:
(30) In this step, the portable electronic apparatus I receives the enlarged content 5′, and calculates a total pixel in width of the enlarged content 5′;
(31) In this step, the portable electronic apparatus 1 determines whether or not the total pixel in width of the enlarged content 5′ exceeds the maximum width of the display range of the display 4; if yes, then goes to step 32, otherwise goes to step 34;
(32) In this step, the portable electronic apparatus 1 displays the enlarged content 5′ that exceeds the maximum width of the display range of the display 4 on a next row, and repeats this step till the enlarged content 5′ of each row does not exceed the maximum width of the display range of the display 4;
(33) In this step, the portable electronic apparatus 1 outputs the enlarged content 5′ in the order as divided in rows as above to the display as shown in FIG. 4, then ends;
(34) In this step, the portable electronic apparatus 1 outputs the enlarged content 5′ to the display 4 and then ends.
(13) In this step, the portable electronic apparatus 1 directly outputs images of the man-machine interface.

In summary, the content 5 of the man-machine interface to be outputted from the portable electronic apparatus 1 is firstly enlarged according to an enlarge parameter and then outputted to the display 4 for displaying. In such a way, the enlarged content 5′ can be viewed on the high resolution display 4.

While the invention herein disclosed has been described by means of specific embodiments, numerous modifications and variations could be made thereto by those skilled in the art without departing from the scope and spirit of the invention set forth in the claims.

What is claimed is:

1. A method of enlarging display content of a portable electronic apparatus having an enlarge display mode, which comprises the following steps for the portable electronic apparatus to output a man-machine interface:
determining whether or not the enlarge display mode is being activated;
when the enlarge display mode is being activated, reading at least one enlarge parameter preset in the enlarge display mode, and enlarging a content outputted by the man-machine interface according to the enlarge parameter, and
canceling an external frame of a decorative screen of the man-machine interface for ornamenting images, and displaying an enlarged content in accordance with the enlarge parameter on a display of the portable electronic apparatus.

2. The method as set forth in claim 1, wherein the portable electronic apparatus is adapted to switch from enabling the enlarge display mode to disabling the enlarge display mode according to a switching signal, or from disabling the enlarge display mode to enabling the enlarge display mode according to the switching signal.

3. The method as set forth in claim 1, wherein when the portable electronic apparatus enters the man-machine interface of the enlarge display mode, at least an enabling/disabling option is presented on the display of the portable electronic apparatus, and a switching signal can be generated by selecting or cancelling the enabling/disabling option which allows the portable electronic apparatus to switch from enabling the enlarge display mode to disabling the enlarge display mode or switch from disabling the enlarge display mode to enabling the enlarge display mode.

4. The method as set forth in claim 1, wherein the enlarge parameter comprises font size, font codes and picture enlarging ratio.

5. The method as set forth in claim 1, wherein the enlarged content is displayed on the display by the portable electronic apparatus according to the following steps: receiving the enlarged content, and calculating a total pixel in width of the enlarged content;
determining whether or not the total pixel in width of the enlarged content exceeds the maximum width of the display range of the display; if yes, displaying the enlarged content that exceeds the maximum width of the display range of the display on a next row, and repeating this step till the enlarged content of each row does not exceed the maximum width of the display range of the display; and
outputting the enlarged content in the order as divided in rows to the display.

6. The method as set forth in claim 5, wherein if the total pixel in width of the enlarged content is determined as not exceeding the maximum width of the display range of the display, then directly displaying the content of the man-machine interface on the display of the portable electronic apparatus.
